(19) United States
(12) Patent Application Publication
(10) Pub. No.: US 2006/0206895 A1
(43) Pub. Date: Sep. 14, 2006

(54) Verification of task completion across a communications network

(76) Inventors: Tom Gray, Newtownabbey (GB); Fred King, Belfast (GB)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/369,495

(22) Filed: Mar. 7, 2006

(30) Foreign Application Priority Data
Mar. 8, 2005 (GB) 0504741.0

(51) Int. Cl. G06F 9/46

(52) U.S. Cl. 718/102

(57) ABSTRACT

A system for the verification of task completion, especially relating to the posting of messages at display sites such as advertising sites. The system comprises a server and a plurality of clients in communication via at least one communications network. At least one of the clients comprises a mobile communications device including means for capturing an image. Each mobile client receives from the server a list of tasks and communicates to the server a respective image captured by the mobile client in respect of the, or each, task. The server, upon receipt of a captured image, causes the image to be stored in association with the respective task.

### FIELD OF THE INVENTION

The present invention relates to the verification of task completion across a communications network. The invention has particular, but not exclusive, application in the field of outdoor advertising.

### BACKGROUND OF THE INVENTION

In the field of outdoor advertising, advertising contractors erect and market advertising billboard/poster sites of various sizes, types, and locations. Types may include both traditional paper poster types and electronic billboards. Site locations may be indoors or outdoors.

Conventionally, contractors market their advertising sites to advertisers via a convoluted chain of independent companies. This chain commonly comprises:
1. The advertiser
2. The advertiser's selected advertising agency
3. An outdoor advertising specialist planning company
4. The contractor

Advertisers brief the advertising agency on the requirements of an advertising campaign. The advertising agency decides on which of the various media types are to be included in the campaign, their merits and the share of each campaign that the various media types are to receive. Then, the advertising agency briefs the outdoor specialist company to plan and implement the outdoor part of the overall advertising campaign.

Taking into account the brief, the outdoor specialist company reviews the contractor's sites and selects one or more of these sites as advertising locations. This may take some time as all transactions involve manual submission of available sites by the contractor (usually by email, fax, written or verbal communication), manual selection of sites by the outdoor specialist, and manual submission by the outdoor specialist to the advertising agency of a report on the chosen sites. The advertising agency then has to include this information in any submission to the advertiser. Changes to selected sites made by the advertiser/advertising agency necessitates repetition of the cycle until the advertiser/advertising agency accepts a final submission.

Upon acceptance of a submission to the advertiser, the outdoor specialist, communicating with one of the contractor's staff, then manually converts the final approved site selections into orders. The individual contractors involved, by manual reports (usually daily in arrears), then relay the progress of the posting, or other execution, of a campaign to the outdoor specialist. No proof of purchase or verification of accuracy of posting is provided other than these retrospective manual reports. Final review of posting activity can therefore take some time, and verification of 100% accuracy of posting of any campaign is considered to be impracticable.

It would be desirable to provide a system that mitigates the problems outlined above.

### SUMMARY OF THE INVENTION

Accordingly, a first aspect of the invention provides a system for the verification of task completion, the system comprising a server and a plurality of clients in communication via a communications network, at least one of the clients comprising a mobile communications device and including means for capturing an image, wherein said at least one mobile client is arranged to receive from said server a list of at least one task and to communicate to the server a respective image captured by said at least one client in respect of the, or each task, the server being arranged, upon receipt of a captured image, to cause the image to be stored in association with the respective task.

Preferably, each task is associated with at least one site, for example an advertising site, the server being arranged to associate a received captured image with a respective site.

The at least one mobile client may include a positioning device for determining its global position. Conveniently, the positioning device takes the form of a GPS (Global Positioning System) receiver. The positioning device determines location data indicating the global position of the respective mobile client. The location data may for example comprise latitude and longitude identifiers.

The at least one mobile client may include means for associating each captured image with at least one identifier and/or other data, for example an indictor of the time and/or date on which the image is captured, and/or location data recorded at the site where the image was taken. More preferably, said at least one mobile client includes means for setting the filename under which a captured image is stored. Advantageously, each captured image is stored with a filename that is indicative of the site at which the image is taken.

The at least one mobile client may include means for requesting a task list from said server. Conveniently, said request includes means for identifying a user of said at least one mobile client in respect of which a task list is requested.

In one embodiment, said at least one mobile client includes means for encoding data, including images, for transmission across said network. The encoding means may implement UUEncoding. The transmission may be performed using HTTP protocol.

A second aspect of the invention provides a mobile communications device including means for capturing an image, said mobile device being arranged to receive from a server a list of at least one task and to communicate to the server a respective image captured by said mobile device in respect of the, or each, task.

A third aspect of the invention provides a computer program product comprising computer program code for installation on a mobile communications device having means for capturing an image, and for enabling said mobile device to receive a list of one or more tasks from said server, causing said mobile device to present said task list to a user, and causing said mobile device to communicate to the server an image captured by said mobile device in respect of the, or each, task.

A fourth aspect of the invention provides a method of verifying task completion in a system comprising a server and a plurality of clients in communication via at least one communications network, at least one of the clients comprising a mobile communications device and including means for capturing an image, the method comprising: providing a list of one or more tasks to said at least one mobile client; capturing, at said at least one mobile client, an image in respect of the, or each, task in the list; storing said image in association with data that associates the image with the respective task; transmitting the image and associated data to the server; storing, at, or in association with, the server, said image and said associated data.

A fifth aspect of the invention provides a system for managing at least one message display site, the system comprising a server and a plurality of clients in communication via at least one communications network, at least one of the clients comprising a mobile communications device and including means for capturing an image, wherein said at least one mobile client is arranged to receive from said server a list of at least one task involving posting a message on at least one message display site, and to communicate to the server a respective image, captured by said at least one client, of a message posted on said at least one message display site, the server being arranged, upon receipt of a captured image, to cause the image to be stored in association with the respective task or message display site.

A sixth aspect of the invention provides a mobile communications device including means for capturing an image, said mobile device being arranged to receive from a server a list of at least one task involving posting a message on at least one message display site, and to communicate to the server a respective image, captured by said at least one client, of a message posted on said at least one message display site.

A seventh aspect of the invention provides a method of managing at least one message display site in a system comprising a server and a plurality of clients in communication via at least one communications network, at least one of the clients comprising a mobile communications device and including means for capturing an image, the method comprising: providing a list of one or more tasks to said at least one mobile client, said at least one task involving posting a message on at least one message display site; capturing, at said at least one mobile client, an image of said at least one display site in respect of the, or each, task in the list; storing said image in association with data that associates the image with the respective task or display site; transmitting the image and associated data to the server; storing, at, or in association with, the server, said image and said associated data.

Other features of the invention are recited in the dependent claims.

When applied to the context of outdoor advertising, preferred embodiments of the invention offer a number of advantages as outlined below.

In certain embodiments, a system is provided or enabled in which one or more contractors' web sites holds details of each poster (or other display) site (typically using numerous data fields).

A user, for example an outdoor specialist, can review the availability and suitability of sites and then select sites in real time with no significant delay or need for communication directly with the contractor's staff.

The advertising agency can review the selected sites in real time over the internet, or other computer or communications network.

Changes in site selection can be made in real time with no significant delay and without direct communication with the contractor's staff.

Site booking can be made in real time with no significant delay and without direct communication with the contractor's staff.

Contractors can pass instructions and/or billposting schedules to their field staff via adapted camera-enabled mobile computing devices, such as PDAs or camera phones, in real time based on automated orders. The mobile devices may be used by billposters to verify location, date, time, and actual poster design utilized. This information, in addition to a photograph of the completed billboard, may be automatically uploaded to the relevant databases on the relevant internet site/sites in real time.

Users of the system, for example the advertiser or advertising agency, can obtain progress reports of various campaigns in real time. Hence, verification of a campaign's progress in real time is enabled and real time proof of posting for users is provided. Moreover, in preferred embodiments, location data is available to verify the global position of a captured image.

In a preferred embodiment, one aspect of the invention comprises an internet based solution including the following components: one or more mobile internet enabled computing device with integrated camera; one or more internet enabled server application; and a wireless communications network by which the computing device(s) and server application(s) may communicate. The, or each, mobile computing device advantageously also includes an integrated positioning device, e.g. an integrated GPS receiver, or a positioning device, e.g. GPS receiver, integrated by a wireless network or connection, e.g. a Bluetooth network/connection. Where a positioning device is provided, the associated mobile device is typically also in wireless communication with a global positioning network, conveniently the GPS satellite network.

The system allows contractors, or other users, to communicate with individuals who post messages at poster/display sites. It also assists other users, e.g. customers of the contractors, to more easily plan advertising campaigns, book campaigns, monitor campaign progress, and obtain proof of progress, all in real time.

In one particular embodiment, the system enables contractors, or other users to: pass instructions to their staff in the field; monitor progress of that staffs' activities; verify posting activity; verify the accuracy of that activity; and allow clients to monitor all activity associated with their advertising campaigns. All the aforesaid being in real time.

Further advantageous aspects of the invention will become apparent to those ordinarily skilled in the art upon review of the following description of a specific embodiment of the invention and with reference to the accompanying drawings.

### BRIEF DESCRIPTION OF THE DRAWINGS

A specific embodiment of the invention is now described by way of example and with reference to the accompanying drawings, in which:

FIG. 1 shows a schematic view of a communications system on which the invention may be implemented;

FIG. 2 is a UML (Universal Modelling Language) model illustrating how a job list may be provided to a mobile device from a remote server;

FIG. 3 is a UML model illustrating how an image may be captured and processed at the mobile device; and

FIG. 4 is a UML model illustrating how a captured image may be communicated to the remote server.

### DETAILED DESCRIPTION OF THE DRAWINGS

The following embodiment is described in the context of outdoor advertising. It will be understood that the invention in its broadest sense is not limited to this context.

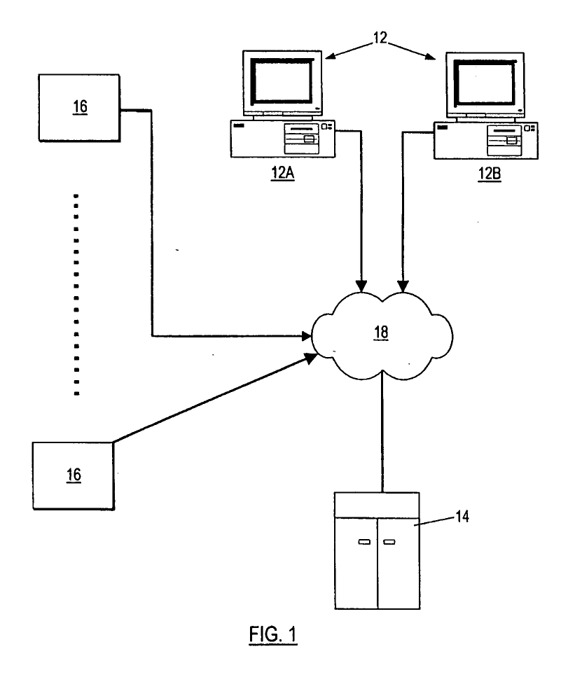

Referring now to FIG. 1 of the drawings, there is shown, generally indicated as 10, a system suitable for use with the present invention. The system 10 comprises at least one client device 12, a server 14 and at least one mobile client device 16. The clients 12, 16 are able to communicate with the server 14 via a communications network 18 which, in a preferred embodiment, includes the internet and a mobile or cellular communications network.

In the present example, it is assumed that the, or each, client device 12 comprises a client station, for example a PC. It is also assumed, for illustration purposes, that one of the client devices 12A is associated with a user in the form of an outdoor advertising contractor, i.e. an organization or individual who is responsible for posting advertisements, or other display material, at one or more display sites (not shown). The sites may be indoors or outdoors and may take any conventional form including sites for displaying paper displays or electronic displays. Client device 12B is assumed, for illustration purposes, to be associated with a user in the form of an advertising agency, or any other organization responsible for ordering and/or monitoring an outdoor advertising campaign. The or each mobile client device 16 may comprise, for example, a mobile (or cellular) telephone, a PDA or other computing device, each including, or being associated with, a camera (not shown). In the present example, each mobile device 16 is internet enabled, i.e. includes the software and hardware necessary to communicate with remote devices via the internet. In preferred embodiments, each mobile device 16 includes a positioning device (not shown) for determining the global position of the device 16. Conveniently, the positioning device takes the form of a GPS (Global Positioning System) receiver. The positioning device determines location data indicating the global position of the respective mobile device (or, more particularly, the global position of the positioning device). The location data may for example comprise latitude and longitude coordinates or identifiers. The positioning device may be fully integrated into the device 16, e.g. an integrated GPS receiver, or may be integrated by a wireless network or connection, e.g. a Bluetooth network/connection. Where a positioning device is provided, the associated mobile device 16 is typically also in wireless communication with a global positioning network, conveniently the GPS satellite network. Typically, the positioning device receives signals from the global positioning network (e.g. signals from a plurality of positioning satellites) and calculates the location data based on the respective received signals, e.g. using conventional techniques, such as triangulation.

In the present example, the server 14 comprises a web server, may take any conventional form and may reside on any suitable host. The server 14 maintains one or more databases, or other storage means (not shown), for storing job lists and for storing data relating to each display site associated with the system 10. The display site data may include, without limitation, one or more of the following: a site identifier; a job identifier; a photograph, or image, of the display site in a current state; location data or coordinates for the site; a control image of the display site in a control state; one or more status identifiers for the site; a timestamp associated with the current state image; a campaign identifier (identifying for example the relevant advertising campaign); a bill poster identifier (identifying the individual responsible for current postings at the site); site data such as site type, location, display/board type, format and/or construction; and classification details such as proximity to feature, research coverage, restrictions and/or mapping coverage.

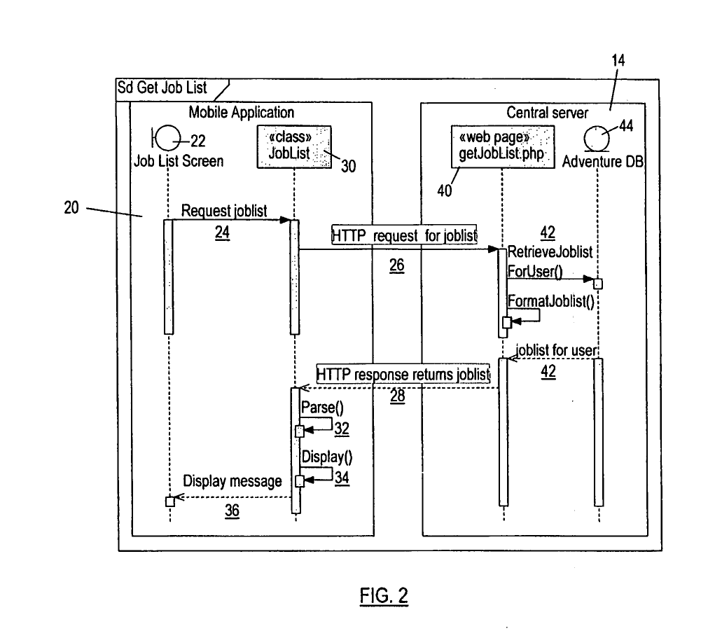

The, or each, mobile client device 16 runs, during use, a computer program, or application, indicated as 20 in FIG. 2. In the preferred embodiment, the mobile client application 20 performs, during use, the following tasks.

1. Retrieval of a job, or task, list from the server 14 and presentation of the job list to a user (not shown). In the present example, the user is assumed to be an individual responsible for posting adverts, or other display items, at one or more display sites. The application 20 presents the user (hereinafter referred to as the bill poster although it will be understood that there is no limitation to posting paper bills) with a retrieved job list, typically a daily job list (not shown). The job list includes one or more tasks to be performed by the bill poster. In the present example, at least some of the tasks include data identifying a display site at which the bill poster is required to post a display item (typically an advertisement). The tasks may also identify the display item to be posted. Typically, the job list includes all tasks to be performed in a given day.

2. Capturing an image of the posting. Once posting has been completed, the bill poster causes an image of the posting to be captured. In the preferred embodiment, the application 20 directs, or prompts, the bill poster to take a photograph (not shown) of the completed posting and, preferably, to confirm that the job is complete. The photograph is stored (usually temporarily) on the mobile device 16 in any convenient manner or format, for example in jpeg format, and associated with the relevant job by means of one or more identifiers (IDs), for example a job ID and/or a site ID and/or a bill poster ID and/or a campaign ID. In one embodiment, the captured photograph is associated with the job that is currently active in the application 20, for example the job that is selected by the bill poster or the job that is being presented to the bill poster. In addition, relevant data or metadata such as a timestamp and/or location data is advantageously associated with the photograph. In preferred embodiments, when an image is captured, the device 16, or application 20, obtains, or at least attempts to obtain, location data, from the positioning device, identifying the global position of the mobile device 16 at or around the time the image is captured. If the location data is not available (e.g. if there is no line of sight from the device 16 to the sky) then the device 16 preferably waits until the location data is available before sending the image and associated data to the server 14. For example, if the image is taken indoors, then the location data may not be available until the device 16 is taken outdoors—the resulting location data gives a satisfactory indication of the location where the image was taken.

3. Sending the image to the server 14. In the present embodiment, the image is transferred or uploaded to the server 14 via the internet. When an internet connection (e.g., a GPRS, 3G or WiFi connection) becomes available to the mobile device 16, the photograph is uploaded to the server 14 along with the associated or attached data (e.g. job ID, site ID, or other identifiers, timestamp and location data). The server 14 causes the, or each relevant, database to be updated with the data (including the photograph or other image) that has been received from the mobile device 16. The server 14 makes the data available to the clients 12 which, in the present example, are internet enabled in order to retrieve or access the data made available by the server 14.

FIG. 2 illustrates an example of how task 1 may be performed. Numerals in parenthesis refer to FIG. 2. The application 20 presents the bill poster with a Job List interface or screen (22) which includes means, e.g. a button, for allowing the bill poster to request a job list. Upon request (24) of a job list by the bill poster, the application 20 requests (26), for example by means of a class or module identified as JobList 30 in FIG. 2, a job list for the bill poster from the server 14. To this end, the request includes a bill poster identifier. In the present example, the request takes the form of a HTTP request to the web server 14. The job list for the bill poster is conveniently formatted as XML and returned (28) to the application 20 in the HTTP response from the server 14. The received job list is parsed (32) and displayed (34) in conventional manner. The JobList module 30 may also display (36) a message that the job list has been successfully retrieved. The JobList module 30 causes the retrieved job list to be stored in any convenient manner.

In the present example, the server 14 includes a module 40 for receiving job list requests from the application 20 of the, or each, mobile device 16. Upon receipt of a job list request, the module 40 retrieves (42), using the bill poster identifier associated with the request, a job list from a database 44 and formats (46) the job list as XML. The formatted job list is transmitted (28) to the application 20 that requested it.

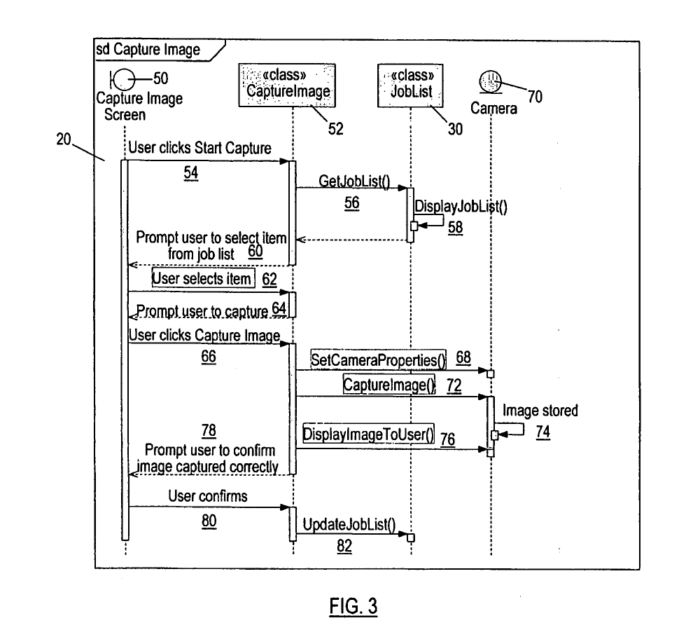

FIG. 3 illustrates an example of how task 2 may be performed. Numerals in parenthesis refer to FIG. 3. The application 20 presents the bill poster with a Capture Image interface or screen 50 which includes means, e.g. a button, for allowing the bill poster to initiate or request the capturing of an image. The application 20 may include, or be associated with, a module (identified as CaptureImage 52 in FIG. 3) for controlling image capture. In response to a request (54) from the bill poster, the module 52 may cause (56) the relevant job list to be displayed (58) to the bill poster (this may conveniently be achieved in association with the JobList module 40 as illustrated in FIG. 3). The module 52 may prompt (60) the bill poster to select a job from the displayed job list in respect of which an image is to be captured. The bill poster, by means of the capture image interface 50, selects (62) the relevant job (typically the job that he has just completed), in response to which the module 52 prompts (64) the bill poster to capture the image.

The capture image interface 50 conveniently also provides the bill poster with means, e.g. a button, for causing an image to be captured. Upon request (66) from the bill poster that an image be captured, the CaptureImage module 52 typically sets (68) the properties of the camera 70 of the mobile device 16. This may, for example, involve setting the required resolution, brightness, etc., for the image, and is conveniently performed via the API provided by the camera 70. Module 52 causes (72) the camera 70 to capture the image, conveniently via the API of the camera 70. Module 52 causes the captured image to be stored (74) in association with an identifier, or name, that advantageously corresponds with the relevant display site, i.e. a site ID. To this end, the module 52 may supply to the camera 70 an appropriate identifier. The module 52 causes (76) the camera 70 to display the captured image to the bill poster and, preferably, prompts (78) the bill poster to confirm that the image has been captured satisfactorily. The interface 50 provides the bill poster with means, e.g. a button, for responding to the prompt (78). Upon confirmation (80) by the bill poster that the image capture was successful, the module 52 updates (82) the job list. This may involve updating a status identifier to indicate that the job is complete and/or associating the relevant job (in this case the job selected by the user at 62) with the captured image. The module 52 may also be adapted to obtain the location data from the positioning device and to associate the location data with the captured image. Conveniently, this is performed after the image is captured.

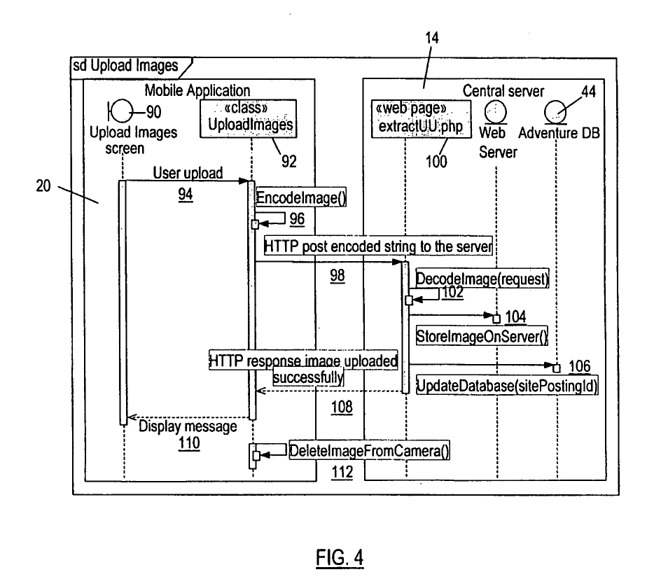

FIG. 4 illustrates an example of how task 3 may be performed. Numerals in parenthesis refer to FIG. 4. The application 20 presents the bill poster with a Capture Image interface or screen 90 which includes means, e.g. a button, for allowing the bill poster to initiate the transfer of one or more captured images to the server 14. The application 20 may include, or be associated with, a module (identified as UploadImages 92 in FIG. 4) for controlling image transfer or upload.

To upload one or more captured images to the server 14, the user clicks, or otherwise activates (94), the “Upload” button on the Upload Images screen 90. Module 92 causes the, or each, image file to be encoded (96) into a format that is suitable for communication to the server 14 across network 18. In the present example, the data transfer across the network 18 is performed using HTTP protocol and the data to be transferred is encoded using the UUEncode algorithm. Hence, in response to action 94, the module 92 encodes, or causes to be encoded, the, or each, file stored on the camera as text using the UUEncode algorithm and posts or transfers (98)same to the server 14. UUEncoding is only required on binary data (jpeg data in this example). In a preferred embodiment, the application 20 is implemented using a Microsoft Windows platform and so UUEncoding is performed implicitly by Windows. Other data to be transferred to the server, e.g. timestamp etc., that comprises ASCII data may be transmitted without explicit encoding (e.g. as URL arguments). Images (and associated data) may be uploaded one at a time (e.g. as soon as possible after capture) or transferred collectively at, for example, a time when the device 16 is otherwise idle, or in any other convenient manner. Transfer may be initiated automatically after capture or in response to user initiation.

The server 14 may include, or be associated with, a module 100 for controlling the receipt of images from the mobile devices 16. Upon receipt of each transmission from the application 20, module 100 causes the image data to be decoded (102). In the present example, images are decoded using the UUDecode algorithm. Module 100 causes each image to be stored (104) in any convenient manner at or accessible to the server 14. The data that is associated with the received image (e.g. timestamp, location data, Site ID, etc.) is used to update database 44 (or other appropriate database). Typically, some data, such as Site ID, may be used as an index to the database—for example, Site ID may determine what is to be updated while other data, such as timestamp, is the updated data. Module 100 may also cause the database 44 to be updated (106) to indicate that the site has been posted. Conveniently, this is achieved using the site_ID that is used as the respective image file name. Upon successful receipt of an image, module 100 may communicate (108) to the application 20 that the upload has been successful. In response to such communication, the UploadImages module 92 may display (110) an appropriate message to the bill poster. In the preferred embodiment, each image file is deleted (112) from the device 16 after it is transferred to the server 14.

It will be understood that the application 20 allows the user to navigate between the various screens or interfaces in any convenient manner.

The network 18 includes a wireless network comprising, for example, a mobile telecommunications network in the form of, for example, GPRS or 3G. Alternatively, the wireless network may be provided by a WiFi or WiMAX operator. It will be understood that any conventional wireless network may be used and may depend on the nature of the mobile device 16. For example, a smart phone device typically supports GPRS and/or 3G whereas a PDA is typically more suited to WiFi connectivity. In any event, the preferred application 20 is not network specific but requires that a wireless network is available to the device 16 and that, in the present example, it supports HTTP for both download of job lists and upload of photographs and attached or associated data.

In the preferred embodiment, the server 14 includes or is associated with a server based application for managing data, especially billboard related data, and, most preferably, data identifying which advertising campaigns have been posted on which billboard(s)/site(s) and when. The server application makes its services available to the client devices 12, the client devices 12 supporting a web application which uses a web browser to communicate with the server application and to present screens to users of the client devices 12.

The completion of a task, in this case the posting of a bill, poster advertisement or other message (whether in paper, electronic or other form), may be verified by referral to the relevant display site data maintained by the server 14 using, for example, the clients 12. The record associated with a given display site will, when updated, include an uploaded image of the site showing the posted bill. The image may be compared with the control image of the display site to assist in the verification process. Further, in the preferred embodiment, the uploaded image is associated with location data that was captured when the image was taken. This location data may be compared with the corresponding control location data stored, or associated, with the display site record. If the comparison indicates that the uploaded location data matches, or substantially matches, the control location data, then this is a further indication that the task has been properly completed. In one embodiment, the server application performs a comparison of the uploaded location data with the control location data and determines whether or not there is a match. The server application may update a location match indicator associated with the display site record to indicate whether or not there is a location match.

It will be apparent from the foregoing that the preferred embodiment enables a billboard owner, or contractor, to manage his portfolio of billboards online and allows an advertising agency or other organization to book outdoor campaigns online. The server application maintains a record of all relevant billboards, or sites, and campaigns and allows a contractor to schedule work for bill posters. As described above, the job schedule data may be made available as a web service over HTTP to the client application 20 running on a mobile device 16. The device 16 passes an identifier representing the bill poster to the server 14 which responds with details of the billboards/sites assigned to the bill poster for that day/period, i.e. a job list. The current status of all display sites is available to the clients 12.

In the preferred embodiment, as the bill poster completes jobs and takes a photograph of the associated billboard/site, the client application 20 temporarily stores the photograph as a jpeg, associates it with the relevant billboard by means of a site identifier (which in turn may identify the current campaign) timestamp information and preferably also location data. When an internet connection becomes available (this may not be immediately if the billboard location is outside an area of coverage), the client application 20 initiates an HTTP upload of the jpeg and associated information to the server 14. The receiving server application will store the jpeg and update relevant data within its permanent database. Pertinent examples of the relevant data may include confirmation that a billboard has been posted at a certain time by a particular bill poster.

The invention is not limited to the embodiment described herein which may be modified or varied without departing from the scope of the invention.

1. A system for the verification of task completion, the system comprising a server and a plurality of clients in communication via at least one communications network, at least one of the clients comprising a mobile communications device and including means for capturing an image, wherein said at least one mobile client is arranged to receive from said server a list of at least one task and to communicate to the server a respective image captured by said at least one client in respect of the, or each, task, the server being arranged, upon receipt of a captured image, to cause the image to be stored in association with the respective task.

2. A system as claimed in claim 1, wherein said mobile client is arranged to store said captured image in association with data relating to the respective task, and to communicate said associated data to the server in association with the captured image, the server being arranged to store the captured image in association with, or in accordance with, said associated data.

3. A system as claimed in claim 1, wherein each task is associated with at least one site, the server being arranged to associate a received captured image with a respective site.

4. A system as claimed in claim 1, wherein said at least one mobile client is arranged to associate said captured image with a respective task identifier being indicative of the task in respect of which the image is captured, and to communicate said task identifier to said server, the server being arranged to store said captured image in association with the task identified by said task identifier.

5. A system as claimed in claim 1, wherein said at least one mobile client is arranged to associate said captured image with a respective site identifier identifying a physical site at which the image is captured, and to communicate said site identifier to said server, the server being arranged to store said captured image in association with said site identifier.

6. A system as claimed in claim 1, wherein said at least one mobile client being arranged to associate said captured image with an indictor of the time and/or date on which the image is captured, and to communicate said indicator to said server, the server being arranged to store said captured image in association with said indicator.

7. A system as claimed in claim 1, wherein said at least one mobile client includes a positioning device for determining location data indicative of the global position of the respective mobile client.

8. A system as claimed in claim 7, wherein said at least one mobile client is arranged to associate location data with the captured image, said location data being indicative of the global position of the site where the image is captured, and to communicate said location data to said server, the server being arranged to store said captured image in association with said location data.

9. A system as claimed in claim 1, wherein said at least one mobile client includes means for setting the filename under which the captured image is stored.

10. A system as claimed in claim 9, wherein said at least one mobile client is arranged to store each captured image with a filename that is indicative of a physical site at which the image is captured.

11. A system as claimed in claim 1, wherein said at least one mobile client includes means for requesting a task list from said server.

12. A system as claimed in claim 11, wherein said requesting means is arranged to send a request including means for identifying a user of said at least one mobile client in respect of which said task list is requested.

13. A system as claimed in claim 1, further including means for storing a respective record for said at least one task, said server being arranged to store a respective captured image in, or in association with, the record for the respective task.

14. A system as claimed in claim 13, wherein the, or each, record includes a respective control image against which the respective captured image may be compared.

15. A system as claimed in claim 13, wherein the, or each, record includes control location data being indicative of a global position associated with the respective task.

16. A system as claimed in claim 13, wherein the server makes said records available to at least one client other than said at least one mobile client via said at least one communications network.

17. A system as claimed in claim 1, wherein said at least one task involves posting a message at a message display site, and wherein the respective captured image is of the respective message display site.

18. A system as claimed in claim 17, wherein said message comprises an advertisement.

19. A mobile communications device including means for capturing an image, said mobile device being arranged to receive from a server a list of at least one task and to communicate to the server a respective image captured by said mobile device in respect of the, or each, task.

20. A computer program product comprising computer program code for installation on a mobile communications device having means for capturing an image, and for enabling said mobile device to receive a list of one or more tasks from said server, causing said mobile device to present said task list to a user, and causing said mobile device to communicate to the server an image captured by said mobile device in respect of the or each task.

21. A method of verifying task completion in a system comprising a server and a plurality of clients in communication via at least one communications network, at least one of the clients comprising a mobile communications device and including means for capturing an image, the method comprising: providing a list of one or more tasks to said at least one mobile client; capturing, at said at least one mobile client, an image in respect of the or each task in the list; storing said image in association with data that associates the image with the respective task; transmitting the image and associated data to the server; storing, at, or in association with, the server, said image and said associated data.

22. A system for managing at least one message display site, the system comprising a server and a plurality of clients in communication via at least one communications network, at least one of the clients comprising a mobile communications device and including means for capturing an image, wherein said at least one mobile client is arranged to receive from said server a list of at least one task involving posting a message on at least one message display site, and to communicate to the server a respective image, captured by said at least one client, of a message posted on said at least one message display site, the server being arranged, upon receipt of a captured image, to cause the image to be stored in association with the respective task or message display site.
